(19) United States
(12) Patent Application Publication
(10) Pub. No.: US 2005/0235311 A1
(43) Pub. Date: Oct. 20, 2005

(54) Reception device to receive data and skin in a markup language

(75) Inventors: Martin Knespel, Vienna (AT); Adolf Proidl, Vienna (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/518,271

(22) PCT Filed: May 26, 2003
(86) PCT No.: PCT/IB03/02286

§ 371 Date: Dec. 16, 2004

(30) Foreign Application Priority Data
Jun. 24, 2002 (EP) 02100743.0

(51) Int. Cl. G06F 17/60

(52) U.S. Cl. 725/36; 725/42; 705/1

(57) ABSTRACT

In a reception device (4, 5) for receiving and processing a transmission signal (US), with reception means (I) for receiving the transmission signal (US), which comprises information data (EPG, VOD) identifying the information content (II) of display information (AI) that can be represented on a display device (6, 7), and which comprises representation-describing data (SK), which identifies the nature of the representation of information contents (II) to be represented on the display device (6, 7), and with processing means (V) for processing this received data (EPG, SK, VOD), and with delivery means (AM) for delivering a display signal (AS) to the display device (6, 7) for displaying the information content (II), the information data (EPG, VOD) and representation-describing data (SK) transmitted in the transmission signal (US) are written in a common Markup Language, but can be transmitted independently of one another in the transmission signal (US), and the processing means (V) comprise only one parser (P) for processing this received data (EPG, SK, VDO).

The invention relates to a reception device for receiving and processing a transmission signal, with reception means for receiving the transmission signal, which comprises information data identifying the information content of display information that can be represented on a display device, and which comprises representation-describing data, which identifies the nature of the representation of information contents to be represented on the display device, and with processing means for processing this received data, and with delivery means for delivering a display signal to the display device for displaying the information content.

The invention further relates to a sender device for sending a transmission signal, which storage means for storing information data identifying the information content of display information that can be represented on a display device, and of representation-describing data, which identifies the nature of the representation of information contents to be represented on the display device, and with processing means for processing the stored data and for delivering the transmission signal comprising this information data and representation-describing data, and with delivery means for delivering the transmission signal.

The invention further relates to a transmission method for transmitting a transmission signal from at least one sender device connected to a computer network to a reception device connected to the computer network, wherein the following steps are executed:
provision in the sender device of the transmission signal comprising information data identifyng the information content of display information that can be represented on a display device, and representation-describing data identifying the nature of the representation of information contents to be represented on the display device;
transmission of the transmission signal from the sender device via the computer network to the reception device;
processing of the transmission signal received in the reception device in order to enable a display of the display information to be represented.

A reception device of this kind, a sender device of this kind and a transmission method of this kind are known from document EP 1 077 405 A2. This document discloses as a sender device a server, which is connected via a computer network to client computers as reception devices, and which enables the use of the client computers via an adaptable user interface. This adaptable user interface is executed as a ‘Wizard’ program, and may be executed on any client computer in the computer network in order to use any (other) client computer in this computer network. The Wizard program may be adapted to the needs of the user of a computer, wherein the user interface may be optimized, for instance, for operating a specific component of the controlled client computer. However, in addition to creating, checking, realizing and making the Wizard program available, this optimization also requires the installation of this Wizard program on the client computer from which the other client computer is to be used.

It has proved a disadvantage here that, during installation of the new Wizard program, the client computer cannot be used to control other client computers, and that making optimized Wizard programs available to all client computers becomes a logistical, time-consuming procedure.

It is an object of the invention to create a reception device in accordance with the generic type mentioned in the first paragraph above, a sender device in accordance with the generic type mentioned in the second paragraph above, and a transmission method in accordance with the generic type mentioned in the third paragraph above, in all of which the disadvantages specified above are prevented. In order to achieve the above-mentioned object, in a reception device of this kind, the information data and representation-describing data transmitted in the transmission signal are written in a common Markup Language, but can be transmitted independently of one another in the transmission signal, and the processing means are equipped with only one parser for processing this received data.

In order to achieve the above-mentioned object, in a sender device of this kind, the information data and representation-describing data transmitted in the transmission signal are written in a common Markup Language, but can be transmitted independently of one another in the transmission signal.

In order to achieve the above-mentioned object, in a transmission method of this kind, the information data and representation-describing data transmitted in the transmission signal are supplied in a common Markup Language, but can be transmitted independently of one another in the transmission signal, and the processing of the transmission signal received in the reception device takes place with only one parser.

By virtue of the features in accordance with the invention, it is achieved that both information data that can be transmitted in the transmission signal and representation-describing data that can be transmitted in the transmission signal are written with a common, universally encountered computer language, namely Markup Language, and therefore can be evaluated with just one parser in the reception device. This gives rise to the advantage that coding means for generating any data to be transmitted in the transmission signal in other computer languages may be dispensed with in the sender device. The advantage is further obtained hereby that further parsers for data of this kind to be transmitted in the transmission signal in a different computer language may be dispensed with in the reception device.

In addition, the advantage is obtained that the changing of the user interface can be undertaken in the background by means of new representation-describing data received in the transmission signal without the user being hampered in the use of the reception device as a result. If, for example, the reception device is formed by a consumer electronic appliance (e.g. DVD−RW or DVD+RW) with which information data comprising television program information (electronic program guide) can be called up and viewed with a display device (e.g. television set), the nature of the representation of the frames and windows in which the television program information is shown can be amended, depending on the nature of the film corresponding to the television program information shown, without a tine delay.

In accordance with the measures defined in claim 2, the advantage is obtained that the Extensible Markup Language is especially well suited to the transmission of information data and representation-describing data. In addition, the advantage is obtained that the development time for developing software routines written in accordance with the Extensible Markup Language is relatively short, and therefore a short “Time to Market” is achieved.

In accordance with the measures defined in claim 3, the advantage is obtained that the reception device is designed to receive this transmission protocol, which is commonly encountered on the Internet, and therefore can communicate with a multiplicity of existing servers.

In accordance with the measures defined in claim 4 and claim 5, the advantage is obtained that the greatest possible flexibility is ensured in respect of changes to the information content shown and of changes to the nature of the representation of the information content.

In accordance with the measures defined in claim 5, the advantage is obtained that both the manufacturer of the reception device and third-party suppliers can provide predefined, extensible representation forms. In addition, the local storing (i.e. mirroring the server representation-describing data in the local memory of the device) has the advantage of a delay-free exchange of the nature of the representation.

In accordance with the measures defined in claim 7, the advantage is obtained that, for example, the fonts and the background for the representation of information contents concerning a science fiction film automatically differ from those for a melodrama.

In accordance with the measures defined in claim 8 and claim 9, the advantage is obtained that the extension of the offering in terms of information and representation diversity, especially by third-party suppliers, can take place with transparency and fully automatically.

In accordance with the measures defined in claim 8 to claim 11, the advantage is obtained that especially advantageous coding types and protocols are used for transmission of the information data and representation-describing data.

The invention will be further described with reference to examples of embodiments shown in the drawings, to which, however, the invention is not restricted.

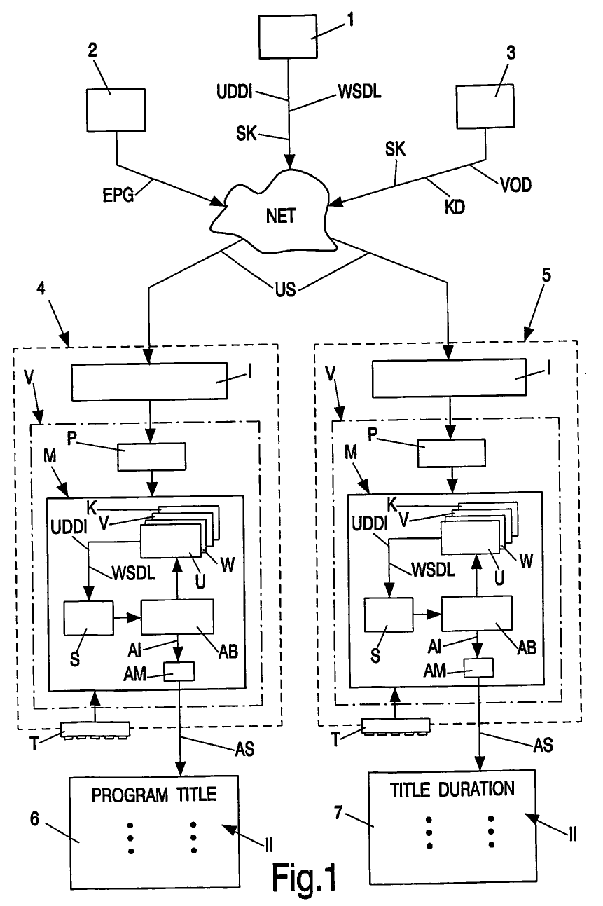

FIG. 1 shows three servers connected to the Internet, which are designed to deliver a transmission signal to a DVD recorder connected to the Internet and a set-top box connected to the Internet.

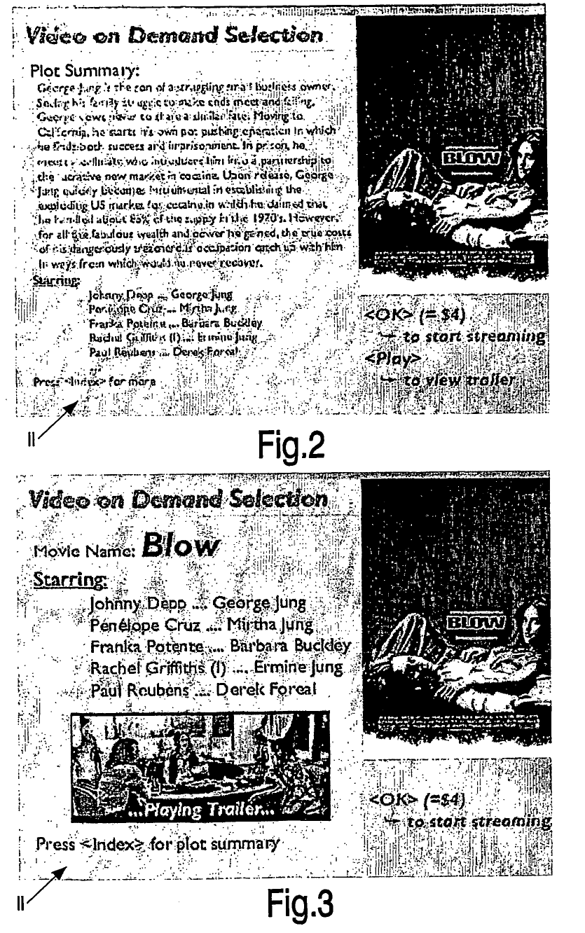

FIG. 2 shows television program information shown on a television set, wherein the nature of the representation of the television program information is defined by representation-described data.

FIG. 3 shows television program information shown on a television set, wherein the nature of the representation of the television program information is defined by further representation-describing data.

FIG. 1 shows a device server 1, an EPG server 2 and a VOD server 3, which form sender devices, and which are connected to a DVD recorder 4 and a set-top box 5, which form reception devices, via the Internet NET. A display signal AS can be delivered from DVD recorder 4 to a first television set 6, and a display signal AS can be delivered from set-top box 5 to a second television set 7 for displaying information contents II. Device server 1 is operated by the manufacturer of DVD recorder 4 and set-top box 5, and provides services for these devices 4 and 5.

Device server 1 comprises storage means for storing service-search data UDDI, service-describing data WSDL and skin data SK, wherein the skin data SK forms representation-describing data to describe the nature of the representation of information contents II on the first television set 6 and the second television set 7. The service-search data UDDI stored in device server 1 enables the manufacturer's devices to interrogate Internet addresses of those servers that store representation-describing data and information data. The service-describing data WSDL stored in device server 1 enables the manufacturer's devices to interrogate as to which representation-describing data and information data can be processed by which type of device.

EPG server 2 is equipped with storage means for storing television program information EPG, which forms information data. Television program information EPG hereby comprises information concerning television programs that can be received from television channels in the coming days. The title, duration, television channel and at least one item of content information relating to each of these television programs are contained in television program information EPG. EPG servers of this kind have been known for a considerable time.

VOD server 3 forms a “video on demand” server, which stores, in storage means, a large number of television films that can be called-up, against payment by a user of set-top box 5, for display on a second television set 7. Also stored in the storage means of VOD server 3 is television program information VOD, which also forms information data, and which comprises information concerning television films that can be called-up from VOD server 3. FIG. 2 and FIG. 3 show television program information VOD of this kind, which can be displayed on the second television set 7, for a television film entitle “Blow” that can be called-up. Also stored in the storage means of VOD server 3 is skin data SK, which, as shown in FIG. 2 and FIG. 3, enables a different way of representing television program information VOD for a television film.

FIG. 1 shows only the elements of DVD recorder 4 and set-top box 5 that are significant in relation to the invention and whose significant properties coincide, for which reason they are described jointly. Both devices 4 and 5 comprise interface means I, which are formed by a modem and designed to communicate with servers 1, 2 and 3 in accordance with the widely known HTTP protocol (Hyper Text Transfer Protocol). This gives rise to the advantage that devices 4 and 5 can communicate with virtually all servers providing information data and representation-describing data on the Internet. Interface means I hereby forms reception means for receiving a transmission signal US, which comprises information data EPG and VDO, which identify the information content of the display information AI that can be represented on first television set 6 or second television set 7, and which comprises skin data SK. Skin data SK forms representation-describing data, and describes the nature of the representation of information contents II to be represented on first television set 6 or second television set 7.

Devices 4 and 5 further comprise processing means V for processing the information data EPG and VOD and skin data SK received in transmission signal US. Processing means V comprises only one parser P, which is designed for processing both the information data EPG and VOD received and skin data SK received. By a parser P, a person skilled in the art understands a program that checks input data for syntactic correctness and breaks it down into its semantic constituents.

Information data EPG and VOD and skin data SK contained in transmission signal US are advantageously written in a common Markup Language, specifically, in particular, an Extensible Markup Language. This gives rise to the advantage that only parser P need be provided in devices 4 and 5 in order to decode the information data EPG and VOD and skin data SK. Coding means for coding the information data EPG and VOD and skin data SK in different coding types can therefore be advantageously dispensed with in servers 1, 2 and 3, resulting in cost savings.

A microcomputer M provided in processing means V executes applications (software modules) to enable the features of devices 4 and 5, and also a search application S and a display-information provision application AB, which will be described in greater detail by reference to the following embodiment examples.

Delivery means AM of processing means V is designed to receive the display information AI and to deliver a display signal AS, which can be processed with the first television set 6 and with the second television set 7. A keypad T is provided for inputting control information by a user to control devices 4 and 5.

In accordance with an embodiment example of the use of set-top box 5, it is assumed that the user has purchased the set-top box 5 and connects it to the Internet NET for the first time. Hereupon, set-top box 5 connects automatically to device server 1, which has an Internet address stored in set-top box 5, and interrogates service-search data UDDI and service-describing data WDSL stored in the storage means of device server 1. Device server 1 is designed to deliver this data UDDI and WSDL in accordance with the Extensible Markup Language, which data UDDI and WSDL is received in transmission signal US by the interface means I of set-top box 5.

Parser P is designed to decode the service-search data UDDI and to store the service-search data UDDI as UDDI object U in storage means of microcomputer M. The UDDI object U hereby comprises inter alia the Internet addresses of EPG server 2 and VOD server 3. Parser P is further designed to decode the service-describing data WSDL and to store the service-describing data WSDL as WSDL object W in the storage means of microcomputer M. The WSDL object U hereby comprises inter alia the information that EPG server 2 contains television program information EPG for television films that can be received from television channels within the next week, and VOD server 3 contains television program information VOD for television films stored in VOD server 3.

In accordance with the embodiment example, let us further assume that the user of set-top box 5 inputs control information using keypad T in order to obtain, displayed on second television set 7, television program information VOD for television films that can be called up from “Video on Demand” servers. Hereupon, search application S searches in UDDI object U and in WSDL object W for these “Video on Demand” servers, and delivers the Internet address of VOD server 3 to the display-information provision application AB. The display information provision application AB hereupon calls up, by means of interface means I, the television program information VOD and skin data SK stored in VOD server 3.

Parser P decodes the television program information VOD coded in accordance with the Extensible Markup Language, and stores the television program information VOD as VOD object V in the storage means of microcomputer M. Parser P further decodes the skin data SK, which is also coded in accordance with the Extensible Markup Language, and stores the skin data SK as SK object K in the storage means of microcomputer M. The display-information provision application AB then reads the television program information VOD for a television film stored in VOD object V, and determines from SK object K the associated nature of the representation of this television program information VOD.

As shown in FIG. 2, it is assumed that it is stipulated by skin data SK that an image of the television film will be represented in the right-hand section, and information on the content of the television film in the top left-hand section, and, finally, the cast of the television film in the bottom left-hand section. The display information provision application AB delivers a corresponding display information AI to the delivery means AM, and this delivers a corresponding display signal AS to the second television set 7.

This gives rise to the advantage that the operator of VOD server 3 has stipulated, by means of the skin data SK assigned to the television program information VOD, the way in which television program information VOD is shown to the user. Owing to the fact that television program information VOD and skin data SK are both written in Extensible Markup Language, set-top box 5 need be equipped with only one parser P.

VOD server 3 is further designed to transmit identification data KD, which identifies the information content of television program information VOD. VOD server 3 hereby transmits, for example for television films belonging to the category “science fiction”, identification data KD differing from that for television films belonging to the category “western”. In addition, VOD server 3 transmits one set of skin data SK per category. The display-information provision application AB is designed to evaluate this identification data KD and to deliver the television program information VOD for a television film in the type of representation assigned to this television film by means of the identification data KD.

It is hereby advantageously achieved that, in the case of television films in the “western” category, for example, the background and the fonts for the characters of the contents information appear in a way that matches the western style. The television program information VOD is thereby represented to the user differently for each category, as a result of which the user is already attuned to the television film and will realize at first glance whether he is interested in television films from this category.

The user can now scroll through the television program information VOD contained in the VOD object and select a television film in which he is interested. By inputting confirmation information with keypad T, he selects a television film, and corresponding information is transmitted to VOD server 3. VOD server 3 then starts to play the selected television film, and deducts a fee from the account of the user of set-top box 5.

In accordance with one embodiment of the use of DVD recorder 4, it is assumed that, following the first connection with the Internet NET, as described above, DVD recorder 4 has identified EPG server 2 as television program information EPG for television films that can be recorded with DVD recorder 2 by evaluation of service-search data UDDI and service-describing data WSDL of device server 1.

DVD recorder 4 now further offers the opportunity of adapting skin data SK in DVD recorder 4 in accordance with the user's wishes, and to store it in storage means of microcomputer M. As shown in FIG. 3, the user has stipulated that a trailer of the television film will be shown in the bottom left-hand section of the television program information EPG shown on first television set 6. If the user now scrolls through television program information EPG concerning television films, which has been called-up from EPG server 2, he will, in accordance with his manually adapted skin data SK, see not the contents information but a short trailer of the particular television film.

The storage of the skin data SK, adapted by the user, in accordance with the Extensible Markup Language as SK object K gives rise to the advantage that it makes no difference whether skin data SK is called up locally from the storage means or via Internet NET from a server. For one set of information data, therefore, multiple sets of representation-describing data can also be received via Internet or locally, and the user can select the set best suited to him.

In accordance with the embodiment example, it is further assumed that the manufacturer of devices 4 and 5 makes skin data SK available for the appropriate devices 4 or 5. Television program information EPG is hereby called up by DVD recorder 4 from EPG server 2, and skin data SK from device server 1, and they can therefore be received independently of one another by DVD recorder 4 in transmission signal US. The manufacturer of devices 4 and 5 can thereby dynamically change the nature of the representation of information data even after the devices have been sold, which is very advantageous.

It may be mentioned that information data may have any information content and may be formed by, for example, cookery recipes, telephone directory information or department store catalog information. Representation-describing data may differ for each type of information content, or may relate to multiple types of information contents.

It may be mentioned that reception devices in accordance with the invention may be provided in a multiplicity of devices in the field of consumer electronics and consumer communications.

It may be mentioned that other Markup Languages, such as GSML and Markup Languages derived from it, are also known, and that the reception device in accordance with the invention could be designed to receive information data and representation-describing data written in accordance with these languages.

It may be mentioned that a sender device in accordance with the invention could also be provided in a television station transmitting via satellite or terrestrial radio

It may be mentioned that the contents data and the representation-describing data may contain dynamic elements, and their change over time and mutual dependencies may be written by means of SMIL, for instance.

It may be mentioned that the conversion of objects into XML documents and the conversion of these XML documents back into objects takes place in accordance with the SOAP Standard.

1. A reception device (4, 5) for receiving and processing a transmission signal (US), with:
reception means (I) for receiving the transmission signal (US), which comprises information data (EPG, VOD) identifying the information content (II) of display information (AI) that can be represented on a display device (6, 7), and which comprises representation-describing data (SK), which identifies the nature of the representation of information contents (II) to be represented on the display device (6, 7), and with processing means (V) for processing this received data (EPG, SK, VOD); and
delivery means (AM) for delivering a display signal (AS) to the display device (6, 7) for displaying the information content (II), characterized in that the information data (EPG, VOD) and representation-describing data (SK) transmitted in the transmission signal (US) are written in a common Markup Language, but can be transmitted independently of one another in the transmission signal (US), and that the processing means (V) comprise only one parser (P) for processing this received data (EPG, SK, VOD).

2. A reception device (4, 5) as claimed in claim 1, characterized in that the information data (EPG, VOD) and the representation-describing data (SK) are coded in an Extensible Markup Language, and that the parser (P) is designed for decoding this data (EPG, SK, VOD).

3. A reception means (4, 5) as claimed in claim 1, characterized in that the reception means (I) are designed to receive the transmission signal (US) transmitted in accordance with an HTTP protocol (Hyper Text Transfer Protocol).

4. A reception device (4, 5) as claimed in claim 1, characterized in that the reception means (I) are designed to receive multiple sets of representation-describing data (SK) for one set of information data (EPG, VOD).

5. A reception device (4, 5) as claimed in claim 1, characterized in that the reception means (I) are designed to receive multiple sets of information data (EPG, VOD) for one set of representation-describing data (SK).

6. A reception device (4, 5) as claimed in claim 4, characterized in that the representation-describing data (SK) can be received via a computer network (NET) by a sender device (1, 2, 3) and/or by storage means of the reception device (4, 5).

7. A reception device (4, 5) as claimed in claim 4, characterized in that identification data (KD), which identifies the information content (II) of the information data (EPG, VOD), can be received with the reception means (I), and that the reception device (4, 5) is designed to generate the display signal (AS) for selecting a set of representation-describing data (SK) for a set of information data (EPG, VOD) in accordance with the identification data (KD).

8. A reception device (4, 5) as claimed in claim 1, characterized in that the processing means (V) are designed to determine available information data (EPG, VOD) and representation-describing data (SK) in accordance with a UDDI (Universal Description Discovery and Integration) protocol.

9. A reception device (4, 5) as claimed in claim 1, characterized in that the reception means (I) are designed to receive service-describing data coded in accordance with a WSDL (Web Services Description Language) coding.

10. A reception device (4, 5) as claimed in claim 1, characterized in that the reception means (I) are designed to receive representation-describing data (SK) transmitted in accordance with a SOAP protocol (Simple Object Application Protocol).

11. A reception device (4, 5) as claimed in claim 1, characterized in that the reception means (I) are designed to receive representation-describing data (SK) coded in accordance with an SMIL (Synchronized Multimedia Integration Language) coding.

12. A sender device (1, 2, 3) for sending a transmission signal (US), with storage means for storing information data (EPG, VOD) identifying the information content (II) of display information (AI) that can be represented on a display device (6, 7), and of representation-describing data (SK), which identifies the nature of the representation of information contents (II) to be represented on the display device (6, 7), and with:
processing means (V) for processing the stored data (EPG, SK, VOD) and for delivering the transmission signal (US) comprising this information data (EPG, VOD) and representation-describing data (SK), and
delivery means (AM) for delivering the transmission signal (US), characterized in that the information data (EPG, VOD) and representation-describing data (SK) transmitted in the transmission signal (US) are written in a common Markup Language, but can be transmitted independently of one another in the transmission signal (US).

13. A sender device (1, 2, 3) as claimed in claim 12, characterized in that the delivery means (AM) are designed to deliver multiple sets of information data (EPG, VOD) for one set of representation-describing data (SK).

14. A transmission method for transmitting a transmission signal (US) from at least one sender device (1, 2, 3) connected to a computer network (NET) to a reception device (4, 5) connected to the computer network (NET), wherein the following steps are executed:
provision in the sender device (1, 2, 3) of the transmission signal (US) comprising information data (EPG, VOD) identifying the information content (II) of display information (AI) that can be represented on a display device (6, 7) and representation-describing data (SK) identifying the nature of the representation of information contents (II) to be represented on the display device (6, 7);
transmission of the transmission signal (US) from the sender device (1, 2, 3) via the computer network (NET) to the reception device (4, 5);
processing of the transmission signal (US) received in the reception device (4, 5) in order to enable a display of the display information to be represented, characterized in that the information data (EPG, VOD) and representation-describing data (SK) transmitted in the transmission signal (US) are provided in a common Markup Language, but can be transmitted independently of one another in the transmission signal (US), and that the processing of the transmission signal (US) received in the reception device (4, 5) takes place with only one parser (P).

15. A transmission method as claimed in claim 14, characterized in that the identification data (KD) identifying the information contents (II) of the information data (EPG, VOD) is provided by the sender device (1, 2, 3) and transmitted to the reception device (4, 5) and that, in order to generate the display signal (AS), the reception device (4, 5) selects a set of representation-describing data (SK) for a set of information data (EPG, VOD) in accordance with the identification data (KD).
